(19) United States
(12) Patent Application Publication
(10) Pub. No.: US 2019/0069345 A1
(43) Pub. Date: Feb. 28, 2019

(54) WAX WARMING DEVICE

(71) Applicant: Diane Davidson, Mississauga (CA)

(72) Inventor: Diane Davidson, Mississauga (CA)

(21) Appl. No.: 15/689,280

(22) Filed: Aug. 29, 2017

(51) Int. Cl. H05B 1/02; H05B 3/24

(52) U.S. Cl. CPC H05B 1/0252; A45D 2200/155; H05B 3/24

(57) ABSTRACT

A wax warming machine may removably retain and warm numerous cans of wax cans, enabling safe and sanitary multiple depilatory treatments and a hygienic waxing experience. The present invention may provide that the wax warming device may comprise a pedestal base, at least one heating component, a housing, a toggle switch, a heat adjustment dial, an indicator light, a heating surface, at least one can of wax, and power chord.

### CROSS-REFERENCE TO RELATED APPLICATION

This application claims priority to U.S. Provisional Application No. 62/381,189 filed on Aug. 30, 2016, the disclosure of which, including any materials incorporated by reference therein, is incorporated herein by reference in its entirety.

### TECHNICAL FIELD

The present invention relates generally to the field of beauty enhancement aids and more specifically relates to a machine configured to heat multiple cans of body wax.

### BACKGROUND

The hair removal industry is reportedly a multi-billion-dollar industry, and appears to be increasing in size. Although shaving has historically been the accepted method to remove unwanted body hair, the small abrasions and cuts created by shaving tend to cause folliculitis, or infection around the hair follicle. If improperly treated, these infections can develop into more serious abscesses that require incision with a scalpel, drainage of the abscess, and antibiotics. Staphylococcus aureus is the most common cause of folliculitis. Although using lasers to remove hair is gaining popularity, women or men who have laser treatments to remove body hair often need to have some waxing done as they were not considered to have had the “adequate” number of sessions to stop hair growth completely. Hair that has less melanin in the hair follicle absorbs less energy from lasers, so those with very light hair (blond, white, and red) will require more treatment sessions to remove and to stop the regrowth hair, and is a more successful treatment for those with darker hair.

Wax has been used for removing unwanted body hair for decades. The rising popularity bikini waxes or Brazilian waxes has prompted an increase in the numbers of waxing salons and spas. Waxing facilities are also frequented by increasing numbers of men who want to appear well-groomed, and have hair removed from various parts of their bodies, especially their chests, genitals, backs and eyebrows. The process for removing hair on any part of the body involves the application of warm wax, which is covered with small strips of cloth. When the wax hardens sufficiently, the cloth is pulled off quickly to remove hair up from the roots. In most waxing salons and beauty salons which offer this service, aestheticians keep a can of wax hot all day so they are ready to care for any clients requesting this procedure. For many users, the idea of everyone sharing the same can of wax is shocking. As a result, some women stopped waxing as those outlets never provided a better alternative solution. Personnel in salons insist that the temperature of the wax is hot enough to prevent the spread of germs and bacteria, yet if the wax were truly that hot, it would burn the skin.

The practice of reusing cans of wax presents health and hygiene issues that are very concerning to consumers. What is needed is a new kind of wax machine that will hold multiple cans of wax at the same time, so clients are not sharing wax from the same can. Such a device would be a safe, hygienic waxing option.

Various attempts to solve this problem have been made. One such attempt can be seen with respect to U.S. Pat. No. 6,053,649, incorporated by reference in its entirety herein, which generally discloses a system for heating and applying a depilatory wax to skin for the removal of unwanted hair. While this disclosure does provide for a wax-warming product, it fails to provide for a device that can hold and warm multiple cans of wax.

Another attempt can be seen with respect to U.S. Pat. No. 7,315,691, incorporated by reference in its entirety herein, which generally discloses a hot wax dispensing device designed to minimize the risk of cross contamination caused by “double dipping” into a community hot wax pot. While this disclosure does provide for a more hygienic solution, it also fails to provide for a device that can hold and warm multiple cans of wax.

Yet another attempt can be seen with respect to U.S. Pat. No. 8,870,029, incorporated by reference in its entirety herein, which generally discloses a heating and dispensing apparatus has a first portion defining a main, active reservoir for the molten material to be dispensed and a second portion has a heater and a seat for pre-heating a supply of replacement molten material. While this disclosure does provide for a multiple-chambered solution, the interconnectedness of the fluid flow and storage compromises the silo-style storage arrangement of the present invention, and makes it an inadequate solution.

Various attempts have been made to solve the problems which may be found in the related art but have thus far been unsuccessful. A need exists for a reliable body wax machine to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as wax, a container, a warmer, etc., are herein meant to include or encompass all equivalents for such elements.

The present invention relates to a wax warming machine that overcomes the deficiencies of the prior art. It is contemplated that the present invention may provide a wax warming device that can retain and heat multiple individual containers of wax. It is believed that the present disclosure provides for a novel solution to the problem of, at least, potential contamination in re-used wax.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

The features of the invention which are believed to be novel are particularly pointed out and distinctly claimed in the concluding portion of the specification. These and other features, aspects, and advantages of the present invention will become better understood with reference to the following drawings and detailed description.

In one embodiment, a wax warming machine (or “body wax machine”) may be comprised of a pedestal base affixed to the bottom of a housing (“or heating component housing”), wherein the housing may contain at least one heating component. In some embodiments, the present invention may provide for at least one main heating component and at least one secondary heating component. The pedestal base and housing for the heating component may be comprised of a plastic or metal material. The outer surface of the housing may be affixed with at least one toggle switch for powering the machine on and off, at least one heat adjustment dial for temperature adjustment, and at least one indicator light which will indicate whether the machine is on or off. The top of the present invention may comprise a heating surface which may be large enough to removably receive one or more cans of wax that may be heated, and in some embodiments, that may be heated in unison.

More specifically, the present invention may comprise a wax warming device comprising at least one support element that may be pedestal-shaped and at least one housing that attached to the support element's upper side. The housing may have a central cavity that opens to the outside via an opening, and the housing may have at least one heating component fixedly connected to the inside walls or floor of the housing in the housing cavity. The at least one heating component may be configured to emanate heat, such as radiating heat or otherwise generating heat and causing the heat to travel in one or more directions. The housing may further provide for at least one heating surface, wherein the heating surface is connected to the housing and spans the housing cavity, and wherein the heating surface is configured to have one or more heating surface cavities that are configured to removably retain at least one can of wax, and wherein the at least one heating surface is placed so as to be warmed by the heat. The present invention may further provide for at least one on/off switch, such as a toggle switch, at least one heat adjustment element, such as a heat adjustment dial, and at least one notification element, such as an indicator light, to be fixedly connected to the housing's outer side or outside. The present invention may further provide for at least one power cord configured to provide electricity to, at least, the at least one heating element, the at least one on/off switch, the at least one heat adjustment element, and the at least one notification element.

In some embodiments, the present invention may further comprise at least one scoop element that may be configured to enable the user to lift or otherwise manipulate one or more cans of wax. The scoop may, in some embodiments, be comprised of a first cylinder-shaped element having one or more raised lips or handle elements. In some embodiments, the scoop may comprise a semi-cylindrical back portion, a raised handle portion, and a flat base portion, wherein the flat base portion may be shaped in size such that it may approximate the base of a can of wax, and the back portion may be configured such that it may retain the curved side of a can of wax. Additionally, it is contemplated that the cylinder may, in some embodiments, define one or more cavities, wherein the cavities may be sized to accommodate the removable reception and retention of at least one can of wax. In other embodiments, the scoop element may be pitcher-shaped, or basket-shaped, or any shape known in the art. In some embodiments, the scoop may be configured to lift, trap, retain, or otherwise affect the flow of wax, in addition to or in substitution of the scoop's can-retaining capability. Additionally, instead of a scoop, in some embodiments, the present invention may provide for one or more tongs, wherein the tongs may be configured to enable a user to lift, set down, move, or otherwise manipulate one or more cans of wax.

In some embodiments, the can of wax may be suitable for eyebrows, upper lips, hands, feet, underarms, the bikini area and any other part of the body where hair removal is needed. The wax may be available with different scents, including almond, vanilla, mango, tropical, and master spice. In some embodiments, the cans of wax may be of any size practicable, with the elements of the present invention scaled to match. By way of illustration and not limitation, such elements may include all elements of the present invention, and more specifically, may include the pedestal base, the heating component, the housing, and the heating surface.

The unique features of the present invention may provide the following benefits for one or more consumers: it may allow beauty salons to use individual cans of wax for each patron; it may enable users to utilize individual cans for each customer it may provide a safe, hygienic waxing experience for consumers; and it may limit the potential for the spreading of germs, bacteria and diseases between clients via wax. Additionally, when provided with individual cans of wax, the consumer may be afforded a more individualized and personalized waxing experience, giving them a degree of customization unlike ever before. More specifically, it may heat multiple cans of wax at once and it may prevent cross-contamination and the spread of disease.

### BRIEF DESCRIPTION OF THE DRAWINGS

These and other features, aspects and advantages of the present invention will become better understood with regard to the following description, appended claims, and accompanying figures where:

FIG. 1 shows a perspective view of a wax warming device in accordance with an embodiment of the invention.

FIG. 2 shows a top-perspective view of a wax warming device in accordance with an embodiment of the invention.

FIG. 3 shows a side-perspective view of a wax warming device in accordance with an embodiment of the invention.

FIG. 4 shows a side-perspective view of at least one element of a wax warming device in accordance with an embodiment of the invention.

### DETAILED DESCRIPTION

The present invention overcomes the limitations of the prior art by providing a new and more effective wax warming device.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

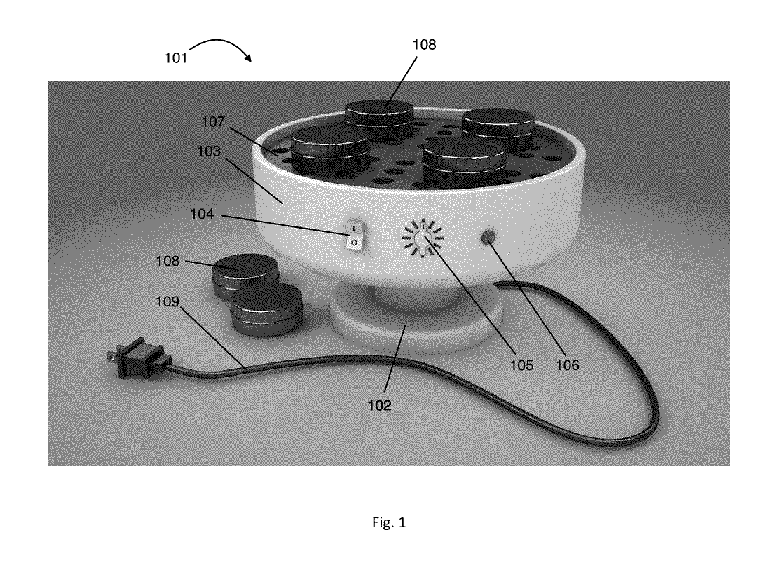

Turning attention to FIG. 1, a perspective view of a wax warming device in accordance with an embodiment of the invention is shown. In the embodiment depicted, a viewer may perceive wax warming device 101, pedestal base 102, housing 103, toggle switch 104, heat adjustment dial 105, indicator light 106, heating surface 107, can of wax 108, and power chord 109. Additionally, at least one heating component may be provided within housing 103, but is not shown in FIG. 1.

In some embodiments, the present invention may provide for another shape in addition to or in substitution of pedestal base 102. By way of illustration and not limitation, such shapes could include a base having legs, a wedge-shaped base, a dome-shaped base, or any shape base known in the art.

Additionally, in some embodiments, housing 103 may be of a different shape than the shape disclosed in FIG. 1, such as by way of illustration and not limitation, a box shape, a sphere, an upside-down pyramid, and any shape housing known in the art.

As well, toggle switch 104, heat adjustment dial 105, indicator light 106 may be of any number, size, shape, or equivalent known in the art. By way of illustration and not limitation, the present invention may provide for one, two, or a plurality of toggle switches 104. In some embodiments, toggle switch 104 may be a sliding element providing for a gradient of “on” or “off” settings. As well, heat adjustment dial 105 may be a sliding element, and the present invention may provide for one, two, or a plurality of heat adjustment dials 105. In some embodiments, heat adjustment dials 105 may provide for one or more settings, either in discrete intervals or along a sliding gradient as described herein. Correspondingly, the present invention may provide for one, two, or a plurality of indicator lights 106, and indicator light 106 may be of any color or combination of colors known in the art.

In some embodiments, heating surface 107 may provide for one or more cavities in addition to a cavity for removably receiving a can of wax 108 as shown in FIG. 1. Additionally, also as shown in FIG. 1, such cavities may of larger and smaller size. In some embodiments, heating surface 107 may provide for one or more tiers. In some embodiments, heating surface 107 may be uneven. In some embodiments heating surface 107 may provide for a minimum of surface area beyond required for removably retaining one or more cans of wax 108.

Heating component, not shown in FIG. 1, may be of any design known in the art to heat wax. By way of illustration and not limitation, the heating component could incorporate a gas-burning heating element, an electrical heating element, a chemical heating agent, or a combination of heating elements or agents. In some embodiments, the heating component may be electrically coupled to power chord 109, wherein the present invention is configured to accept electrical power and pass it to the heating component, wherein the heating component may generate heat that warms at least one can of wax 108.

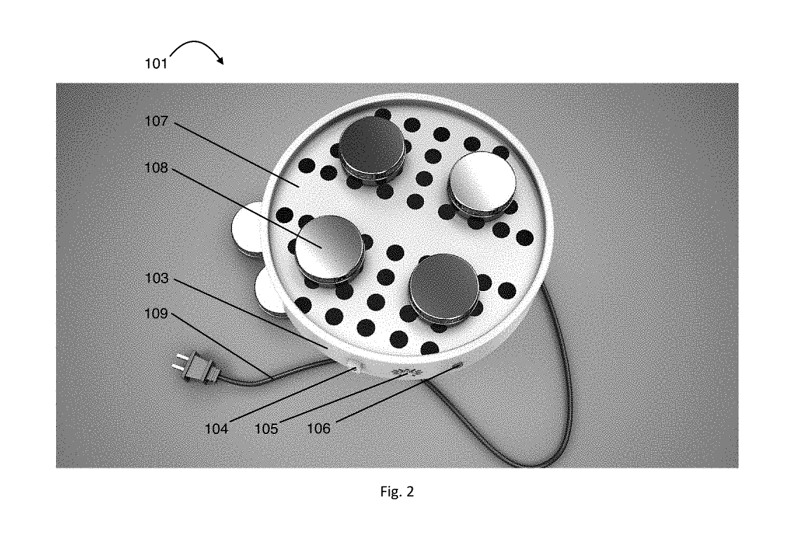

With respect to FIG. 2, a top-perspective view of a wax warming device in accordance with an embodiment of the invention is shown. In the embodiment depicted, a viewer may perceive wax warming device 101, housing 103, heating component (not shown), toggle switch 104, heat adjustment dial 105, indicator light 106, heating surface 107, can of wax 108, and power chord 109. In the embodiment depicted in FIG. 2, at least one heating component may be provided within housing 103, but is not shown in FIG. 2.

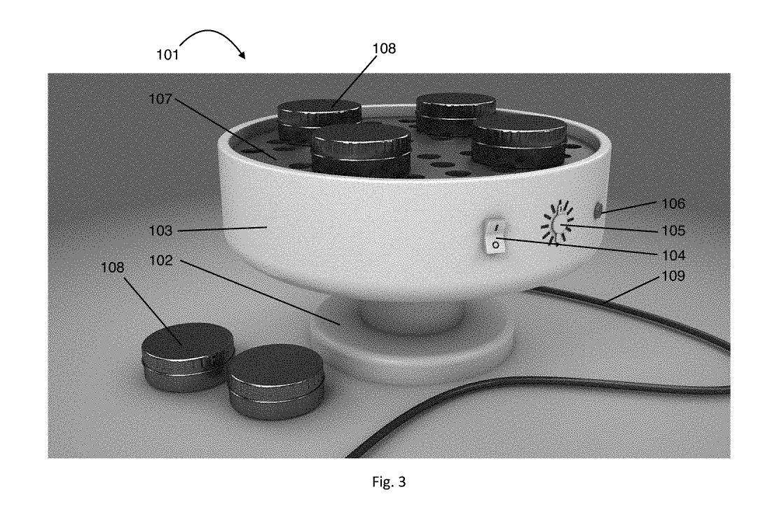

With respect to FIG. 3, side-perspective view of a wax warming device in accordance with an embodiment of the invention is shown. In the embodiment depicted, a viewer may perceive wax warming device 101, pedestal base 102, housing 103, heating component (not shown), toggle switch 104, heat adjustment dial 105, indicator light 106, heating surface 107, can of wax 108, and power chord 109. In the embodiment depicted in FIG. 3, at least one heating component may be provided within housing 103, but is not shown in FIG. 3.

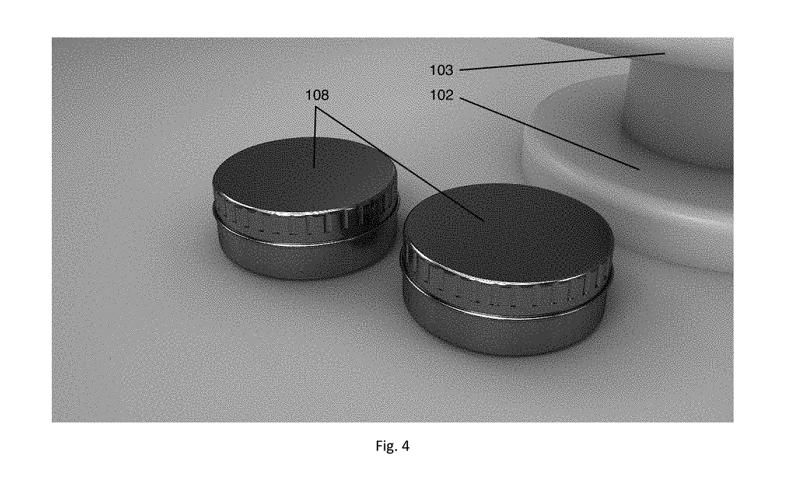

With respect to FIG. 4, a side-perspective view of at least one element of a wax warming device in accordance with an embodiment of the invention is shown. In the embodiment depicted, a viewer may perceive pedestal base 102, housing 103, and can of wax 108.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the wax warming device generally described herein has been disclosed in connection with a number of embodiments shown and described in detail, various modifications should be readily apparent to those of skill in the art.

What is claimed is:

1. A wax warming device, comprising:
at least one support element having at least one upper support portion and at least one lower support portion;
at least one housing having at least one housing outside, at least one housing inside, at least one housing lower side, and at least one housing upper side, wherein the at least one housing lower side is connected to the at least one upper support portion, and wherein the at least one housing defines at least one housing cavity having at least one housing opening;
at least one heating component fixedly connected to the at least one housing inside, wherein the heating component is configured to emanate heat in at least one direction;
at least one heating surface connected to the at least one housing, wherein the at least one heating surface is configured to span the at least one housing cavity, and wherein the at least one heating surface is positioned between the heating component and the at least one housing opening, such that the at least one heating surface is warmed by the heat;
at least one on/off switch fixedly connected to the at least one housing outside, wherein when the at least one on/off switch is in the “on” position, the on/off switch is configured to cause the at least one heating component to emanate heat, and wherein when the at least one on/off switch is in the “off” position, the on/off switch is configured to not allow the at least one heating component to emanate heat;
at least one heat adjustment element fixedly connected to the at least one housing outside, wherein the at least one heat adjustment element is configured to adjust the intensity of the heat emanated by the at least one heating component when the at least one heating component is caused to emanate heat;
at least one notification element fixedly connected to the at least one housing outside; and
at least one power cord, wherein the at least one power cord is configured to receive electricity from a power source and to transmit electricity to the at least one heating element, the at least one on/off switch, and the at least one notification element.

2. The wax warming device of claim 1, wherein the at least one support element is a pedestal base.

3. The wax warming device of claim 1, wherein the at least one housing opening opens towards the at least one housing upper side.

4. The wax warming device of claim 1, wherein the at least one heating surface defines at least one heating surface cavity, and wherein the at least one heating surface cavity is configured to removably receive at least one can of wax.

5. The wax warming device of claim 1, wherein the at least one on/off switch is at least one toggle switch.

6. The wax warming device of claim 1, wherein the at least one heat adjustment element is at least one heat adjustment dial.

7. The wax warming device of claim 1, wherein the at least one heat notification element is at least one indicator light.

8. The wax warming device of claim 1, wherein the at least one heating component is an electric heater.

9. A body wax machine designed to heat multiple cans of wax at the same time essentially as described herein.
